(19) United States
(12) Patent Application Publication
(10) Pub. No.: US 2009/0098523 A1
(43) Pub. Date: Apr. 16, 2009

(54) Punched Key and Pictorial Code for Identifying True Choice in a Multiple Choice Questions

(76) Inventor: Farid Shahriari, Tehran (IR)

Correspondence Address: BARRY CHOOBIN, 193 SUITE #18, TALEGHANI, BAHARE SHOMALI, TEHRAN, 1563714311, IR

(21) Appl. No.: 12/248,909

(22) Filed: Oct. 10, 2008

(51) Int. Cl. G09B 3/00

(52) U.S. Cl. 434/327

(57) ABSTRACT

An answer key for use in answering multiple-choice questions is configured to provide immediate feedback to an examinee as to whether correct response has been made for each question. The key comprises a substrate having a plurality of similar geometric shaped holes and at least one geometric shaped hole being different in characteristic to said plurality of similar geometric shaped holes. Under each multiple question a line coded is printed comprising a plurality of similar shaped drawings and at least one shaped drawing which are arranged in X row. The at least one shaped drawing is shaped differently from said plurality of similar shaped drawings, wherein one of the similar shaped drawings corresponds to said correct response. The correct response is identified by placing the answer key on the coded line.

### FIELD OF THE INVENTION

The present invention relates generally to educational testing systems, and more particularly to a multiple choice testing system and method providing immediate feedback as to the correctness of an answer choice, thereby facilitating learning and improving retention.

### BACKGROUND OF THE INVENTION

Research has shown that feedback in the form of knowledge of test results is highly beneficial for learning, with the maximum benefit accruing when the time delay between the production of the results and the feedback is minimal. Still, many examiners administer multiple-choice examinations with answer forms on which examinees typically darken one space (labeled A, B, C or D) in a row of spaces for each of a number of questions to indicate their preferred responses to the questions. This typical answer form is unable to inform the examinee whether or not a response was correct or incorrect at the time the response is made. At a later time, examinees' answer forms may be returned with indices noting the correct responses. However, unless examinees have perfect recall of the test questions, and the order in which they appeared on the examination, the typical answer forms do not provide examinees with knowledge of the particular questions they responded to correctly and those that they did not.

Learning results in a relatively permanent change in behavior or mental associations as a function of experience with feedback. Research has shown that delaying informative feedback about the correctness of one's responses for as little as 12 seconds in a problem-solving task may significantly reduce the ease of learning and also decrease overall retention. It is clear that an answer form that would provide immediate informative feedback for the correctness of an examinees' responses would facilitate learning and improve retention.

An optimal examination procedure would be one that would include an answer form that would assess what the examinee knows as well as immediately provide feedback about incorrect responses while teaching the correct ones. Such an answer form would be a more efficient use of time and a significant improvement over the current methodology. The immediate feedback answer form would teach new knowledge at the same time it assesses current knowledge. Currently used multiple-choice forms do not provide corrective feedback to the examinee at the time of responding. Therefore, an opportunity to teach the correct response to a problem is lost. In addition, if later questions on an examination relate to information from earlier questions, an examinee who incorrectly answers a question on the current answer forms, where there is no corrective feedback, is more likely to miss the later ones. That is, an examinee's responses on a typical multiple-choice answer form may misgauge his level of understanding and his ability to profit from timely instruction.

An advantage of current multiple-choice answer forms is their ability to be scored automatically by a scanning device that is sensitive to the darkened option in a row of options for each question, for example. The “correct” option is the space on the answer form (labeled A, B, C or D, etc.) that corresponds to a similarly labeled answer option on the test form. If an incorrect answer option is darkened on the answer form, or if more than one space in a given row of options is darkened, the scanning machine automatically records the examinee's response as incorrect for that particular question. The total number of correctly marked answer options is typically recorded by the scoring machine and printed on the test form. The ease of assessing test results of large numbers of examinees has made the use of scannable, multiple-choice answer forms extremely popular.

There are many books in the USA and other countries that include multiple choice questions. The use of these books should access to true answers after answering to each questions and selection one of the questions. Interesting! Till the time the user does not answer to questions, he or she should not access to the true answer but after answering it is necessary to be informed of the true answer. The traditional method which is used in these books is presenting correct answer at the end of the book and/or at the end of a series of questions. In some circumstances, presenting the true choice is accompanied with some descriptions regarding the reason of trueness of the choices.

Three are two problems for the users of these kinds of books—the books including multiple choice questions. The first problem is finding the page showing the true answers and the second problem is that in case of existing description about true answer, the book reader inevitably sees these descriptions and if his/her answer, thus loosing the chance to rethink about the question; in addition allocating some pages of book only for describing the answers has some disadvantages: voluminous and increasing the cost of the book.

For the foregoing reasons, there is a need for a test-scoring method and apparatus that can be applied to multiple choice tests, that provides immediate feedback as to the correctness of each answer choice to the examinee, and that provides means for calculating and scoring partial credit based on the number of incorrect choices the examinee made before choosing the correct answer.

### SUMMARY OF THE INVENTION

An object of this invention is to provide a test answer form for multiple-choice examinations that can be administered to a large number of examinees to assess their knowledge of examination questions while at the same time teaching them the answers to the questions that they initially answered incorrectly.

Another object of the invention is to provide an immediate feedback multiple-choice examination form designed to confirm to an examinee his/her correct responses and incorrect responses.

Another object of the invention is to enable a test examiner to allocate partial credit for a correct response to a question that was made subsequent to a previous incorrect response or responses to that question on a multiple-choice answer form for one embodiment of the invention.

Another object of the invention is to maximize multiple-choice examination security.

A further object of the invention is to provide a feedback form useful for scoring games and contests, providing entertainment, and providing programmed learning via an immediate feedback scoring system with a partial credit option.

In one embodiment of the invention, with the problems of the prior art in mind, various of the objects of the invention are provided by a unique answer form having under each question some shapes in a row as a “code” and a punched key used as “decoder. If the decoder key sets on the code, the true choice which is in one of punches will be appeared. So this invention is a collection of a pictorial code and a punched key as a decoder.

In another embodiment of the invention, the security related objects of the invention are met by creating more than one version of the answer form, each with a different predetermined pattern of indicators for marking correct answers in the answer spaces.

### BRIEF DESCRIPTION OF THE DRAWINGS

Aspects, features, benefits and advantages of the embodiments of the present invention will be apparent with regard to the following description, appended claims and accompanying drawings where:

FIG. 1: Shows a key by five holes, four similar holes. One of the holes is different from other shapes.

FIG. 2: Shows a pictorial code to be used when the choice 1 is correct.

FIG. 3: Shows a pictorial code to be used when the choice 2 is correct.

FIG. 4: Shows a pictorial code to be used when the choice 3 is correct.

FIG. 5: Shows a pictorial code to be used when the choice 4 is correct.

FIG. 6: It compares the status of holes of key with the code related to choice 1.

FIG. 7: It shows the status of key when it is in conformity with the code related to choice 1.

FIG. 8: It compares the status of holes of key with the code related to choice 2.

FIG. 9: It shows the status of key when it is in conformity with the code related to choice 2.

FIG. 10: It compares the status of holes of key with the code related to choice 3.

FIG. 11: It shows the status of key when it is in conformity with the code related to choice 3.

FIG. 12: It compares the status of holes of key with the code related to choice 4.

FIG. 13: It shows the status of key when it is in conformity with the code related to choice 4.

FIG. 14: It shows a page of a book that under each question of it, the code related to true choice is used.

FIG. 15: It shows the manner of seeing of the true choice by using the decoder keys.

### DETAILED DESCRIPTION OF THE INVENTION

The present innovation is used for showing the true choice of a multiple choice question.

A multiple choice question may consist of two, three or more choices that one of them is true answer. Here, it is considered a four choices question but the fact is this description is valid for the status that the number of the choices is different.

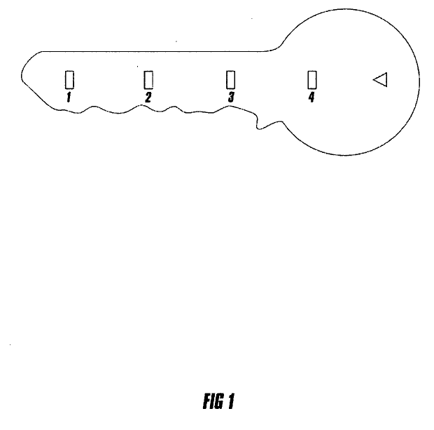

FIG. 1 illustrates a plurality of holes with 4 rectangle-like shapes with an equal distance from each other and one triangle shaped hole. It is necessary that the four holes of the key be similar in shape and the fifth hole be different in shape from other holes. The look like holes is shown as 1, 2, 3, and 4.

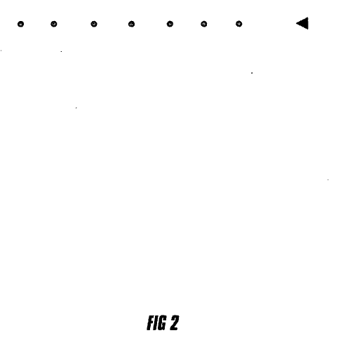

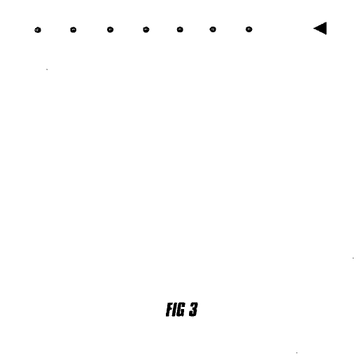

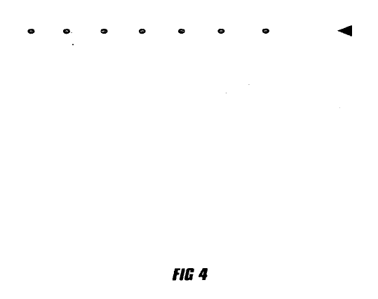

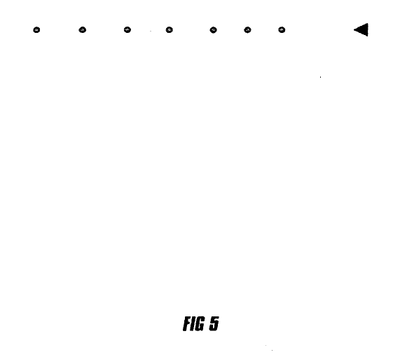

FIG. 2-FIG. 5, illustrate a pictorial code which is used in case that the choice 1 is correct. Also in FIGS. 3, 4 and 5 the pictorial codes related to choices 2, 3 and 4 are shown.

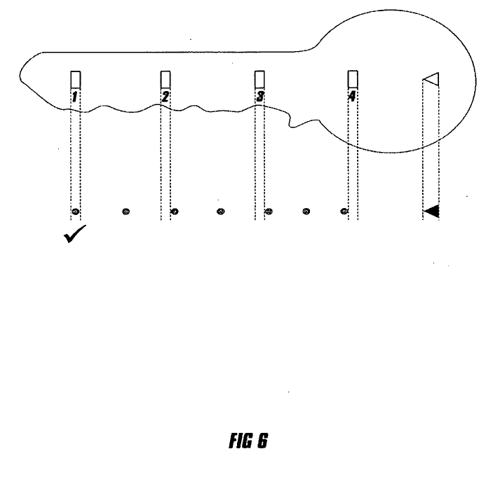

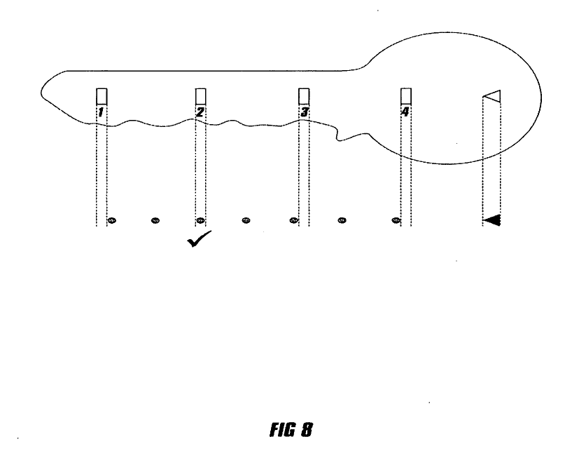

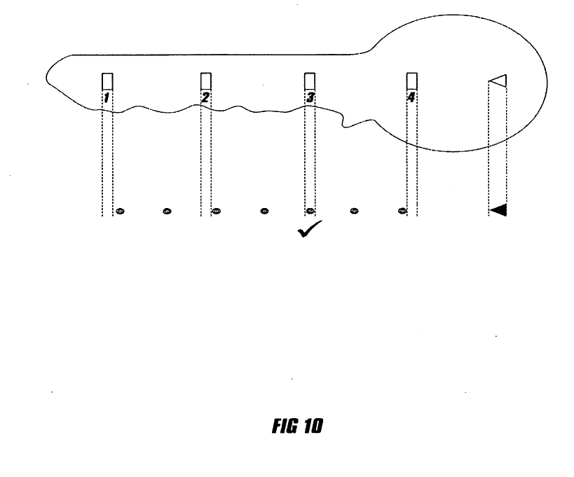

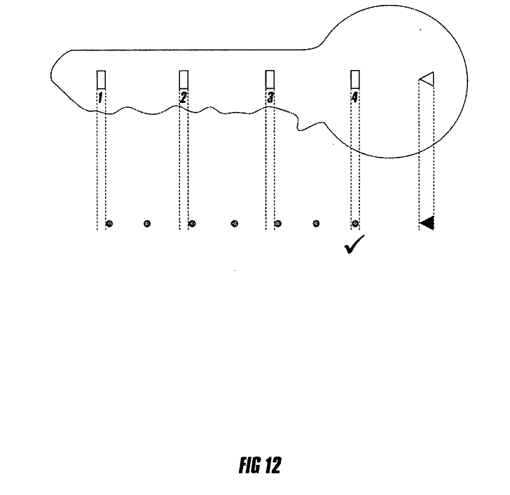

FIGS. 6, 8, 10 and 12 illustrate the triangle-shape of the hole is on the triangle-shape code in a manner that only one of the shapes of code is opposite to one hole of the key. Also in FIGS. 8, 10 and 12 this matter is shown for other holes of key.

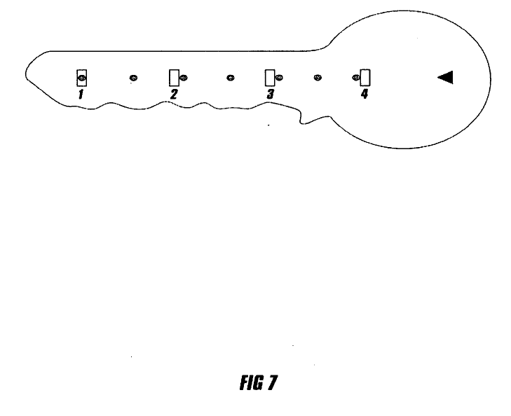

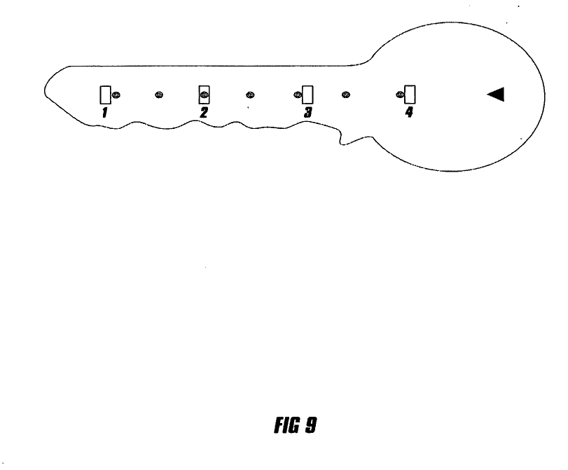

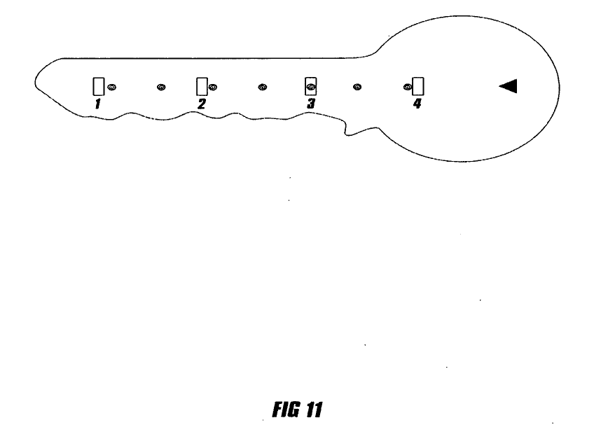

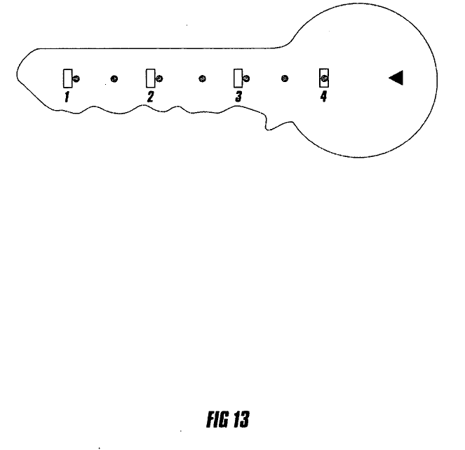

FIGS. 7, 9, 11, and 13 illustrate setting the triangle-shape hole on triangle-shape key, only one of other shapes of code is seen in hole 1, i.e. the true answer is choice 1. FIGS. 9, 11 and 13 show the status of the key when choices 2, 3 and/or 4 are correct.

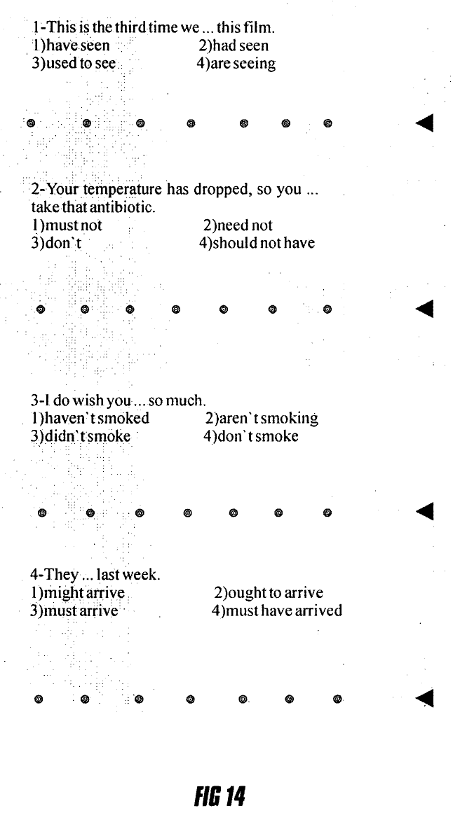

FIG. 14 shows the status of a book that used pictorial code under each question. The pictorial codes considering the true choice are located under each question and in the same time separate the questions.

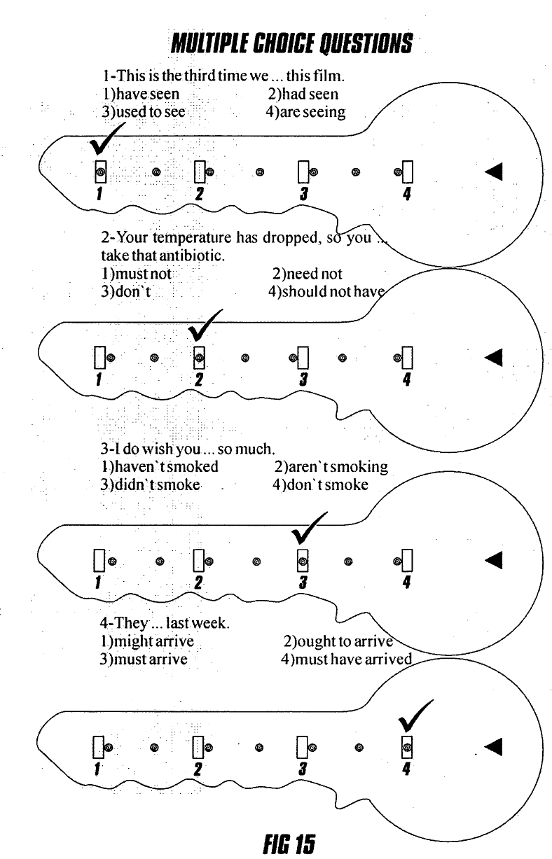

FIG. 15 is an illustration of after answering the questions, the book user by setting key will be informed of the true choice.

The tests can then be prepared with the answers to the questions keyed appropriately, thereby reducing the need to manufacture new forms for each test. A limited number of test forms, with the questions correspondingly arranged, can be used for any one test, thereby maintaining test security while minimizing the testing complexity. These would provide different sets of the test forms for a given test.

Although various embodiments of the invention have been shown and described, they are not meant to be limiting. Those of skill in the art may recognize various modifications to these embodiments, which modifications are meant to be covered by the spirit and scope of the appended claims.

I claim:

1. A method for identifying a correct choice in multiple choice questions wherein said correct choice is identified in the vicinity of said multiple choice question, comprising:
Providing an answer key, wherein said answer key comprises a substrate wherein said substrate comprises a plurality of similar geometric shaped holes and at least one geometric shaped hole arranged in X row, and wherein said at least one geometric shaped hole is shaped differently from said plurality of similar geometric shaped holes;
Printing at least one multiple choice question in a page;
Printing a coded line under said at least one multiple choice question, wherein said coded line is printed within said page and wherein said coded line comprises of:
a plurality of similar shaped drawings and at least one shaped drawing arranged in X row, wherein said at least one shaped drawing is shaped differently from said plurality of similar shaped drawings, wherein one of the similar shaped drawings corresponds to said correct choice;
Placing said answer key on said coded line;
Matching said at least one geometric shaped hole which is shaped differently from said plurality of similar geometric shaped holes with said at least one shape drawing being different in shape from said plurality of similar shape drawings; and
Identifying said correct choice by appearance of said one of the similar shape drawing corresponding to said correct choice through one of said similar shape holes.

2. The method as claimed in claim 1, wherein each of said plurality of similar shape drawings are smaller in size than each of said plurality of similar geometric shaped holes.

3. The method as claimed in claim 1, wherein said at least one geometric shaped hole which is shaped differently from said plurality of similar geometric shaped holes is equal in size with said at least one shape drawing being different in shape from said plurality of similar shape drawings.

4. A system for identifying a correct choice in multiple choice questions wherein said correct choice is identified in the vicinity of said multiple choice question, comprising:
an answer key, wherein said answer key comprises a substrate wherein said substrate comprises a plurality of similar geometric shaped holes and at least one geometric shaped hole arranged in X row, and wherein said at least one geometric shaped hole is shaped differently from said plurality of similar geometric shaped holes;
Means for printing at least one multiple choice question in a page;
Means for printing a coded line under said at least one multiple choice question, wherein said coded line is printed within said page and wherein said coded line comprises of:
a plurality of similar shaped drawings and at least one shaped drawing arranged in X row, wherein said at least one shaped drawing is shaped differently from said plurality of similar shaped drawings, wherein one of the similar shaped drawings corresponds to said correct choice;
means for matching said at least one geometric shaped hole which is shaped differently from said plurality of similar geometric shaped holes with said at least one shape drawing being different in shape from said plurality of similar shape drawings; and
Means for identifying said correct choice by appearance of said one of the similar shape drawing corresponding to said correct choice through one of said similar shape holes.

5. The system as claimed in claim 4, wherein each of said plurality of similar shape drawings are smaller in size than each of said plurality of similar geometric shaped holes.

6. The system as claimed in claim 4, wherein said at least one geometric shaped hole which is shaped differently from said plurality of similar geometric shaped holes is equal in size with said at least one shape drawing being different in shape from said plurality of similar shape drawings.
